(19) United States
(12) Patent Application Publication
(10) Pub. No.: US 2008/0257147 A1
(43) Pub. Date: Oct. 23, 2008

(54) Gas Distributor

(75) Inventor: Jonathan Philip Gregory, Hampshire (GB)

Correspondence Address: RATNERPRESTIA, P O BOX 980, VALLEY FORGE, PA, 19482-0980, US

(73) Assignee: Johnson Matthey PLC, London (GB)

(21) Appl. No.: 12/096,499

(22) PCT Filed: Nov. 7, 2006
(86) PCT No.: PCT/GB2006/050373

§ 371 Date: Jun. 6, 2008

(30) Foreign Application Priority Data
Dec. 6, 2005 (GB) 052483938
Mar. 2, 2006 (GB) 0604166.9

(51) Int. Cl. B01D 53/22

(52) U.S. Cl. 95/46; 96/6

(57) ABSTRACT

A gas distributor, for distributing a gas that contains an entrained liquid, comprises a body with upper (14,16) and lower perforate sections (18,20) and liquid separation means (22,28) disposed within said body between said upper (14) and lower (18) sections that coalesces at least part of the liquid entrained in the gas. A vessel (50), e.g. a catalyst (56) or sorbent vessel comprises the distributor and a process for distributing a gas and the separated liquid to a vessel using the distributor.

This invention relates to a gas distributor for distributing a gas that contains an entrained liquid.

Gas distributors typically comprise one or more perforate bodies to which the gas is fed. Typical gas distributors are perforated-pipe distributors that comprise one or more pipes in which are drilled a series of holes. Another type of distributor is the slot-type distributor that has slots cut into the pipe or pipes rather than holes (see Perry's Chemical Engineering Handbook, 5-48 and 5-49).

Many gas streams are contaminated with entrained liquid. In some circumstances it is desirable to separate, collect and distribute this liquid evenly within the vessel. For example U.S. Pat. No. 4,579,647 describes a vessel, containing a bed of catalyst, having a gas distributor that collects liquid entrained within the gas, divides the liquid into a plurality of spaced apart liquid streams and directs the streams evenly over the catalyst bed. The gas distributor depicted comprises a perforate cylinder having an upper gas distribution section and a lower liquid collection section with radial pipes extending horizontally from the lower section. The separation of liquid in the distributor depicted relies merely on the disengagement of liquid on the internal walls of the distributor. This is not particularly efficient but is satisfactory for a duty where the liquid is to be fed evenly to the bed of catalyst.

In contrast, we have found that entrained liquid may be a source of catalyst or sorbent degradation that may reduce the effectiveness of the catalyst or sorbent. For example, liquid hydrocarbons or water entrained in the gas can coat the outside of the catalyst or sorbent pellets or granules and block the pores thereby reducing the surface area available for catalysis or sorbency. Secondly, liquids can cause erosion or solubilisation of components from the catalyst or sorbent thereby reducing the activity and leading potentially to increased pressure drop through the bed. Reduced effectiveness and Increased pressure drop are undesirable as these lead to reduced throughput and increased compression costs.

We have devised a means for overcoming these problems.

Accordingly the invention provides a gas distributor, for distributing a gas that contains an entrained liquid, comprising a body with upper and lower perforate sections and liquid separation means disposed within said body between said upper and lower sections that coalesces at least part of the liquid entrained in the gas.

The gas distributor of the present invention need not be limited to use in catalyst or sorbent vessels but may be used in other vessels where effective liquid separation is desired for example, the gas distributor may be used in a gas scrubbing vessel or a gas separator vessel. In a gas scrubbing vessel, the gas distributor provides a method to separate entrained liquid from the gas stream and feed the resulting liquid-depleted gas and separated liquid to specific parts of the vessel. In this way the efficiency of the scrubbing process is increased. In a gas separator vessel, the gas distributor provides a means for ‘pre-separation’ before the gas stream is contacted with other separation means located within the vessel. In this way the effectiveness of the separator may be increased.

Accordingly, the invention further provides a vessel having the above gas distributor and a process for distributing a gas containing an entrained liquid to a vessel comprising the steps; (i) passing a gas stream containing entrained liquid to the above gas distributor, and (ii) passing the resulting liquid and liquid-depleted gas streams from said distributor through a vessel.

Preferably however, the gas distributor is used in a catalyst or sorbent vessel where it is an object of the invention to separate entrained liquid from the gas fed to a catalyst or sorbent vessel while at the same time distributing the resulting liquid-depleted gas evenly to the catalyst or sorbent. The separated liquid may be conducted away from the catalyst or sorbent, or passed through a minor portion of the bed. In this way the majority of the bed is protected from the liquid leading to overall increased on-line operation of the catalyst or sorbent.

The gas distributor preferably comprises a body having wet gas inlet means and adjacent upper and lower perforate sections (which may also be termed “first” and “second” perforate sections respectively) with liquid separation means within the body between said upper and lower sections that coalesce liquid droplets entrained in the wet gas entering the upper perforate section via the inlet means, and allow the coalesced liquid to pass to the lower section, said upper section thereby providing a liquid-depleted gas stream to the vessel and the lower section a liquid-enriched stream to the vessel.

The body may be any suitable shape for the vessel, but is preferably complimentary in shape to the vessel in which it is to be disposed. For example the distributor may be an elongate body with an octagonal, square, hexagonal, oval or circular cross-section. For ease of fabrication, preferably the body is cylindrical.

The liquid separation means may comprise one or more impact plates, a porous mesh or gauze, porous pellets, open cellular foam or the like. One or more types of liquid separation means may be employed. For ease of fabrication and maintenance, the liquid separation means preferably comprises one or more inclined surfaces, for example one or more inclined baffles or plates, which may be curved, e.g. in the form of a cone. By “inclined” we mean at an angle, between 20 and 70 degrees, preferably 30 and 60 degrees to the axis of the distributor.

Howsoever the inclined surfaces are arranged, the liquid separation means should be arranged within the body to allow the coalesced liquid to pass from the upper section to the lower section. Thus preferably the gas distributor is located in the vessel so that the coalesced liquid may pass under the force of gravity downwards from the separating means to the lower section and thence to the vessel.

Preferably the inclined surfaces of the liquid separation means have an overlayer of a porous material that enhances disengagement of the liquid from the gas by preventing re-entrainment of the liquid in the gas moving over the inclined surface. The porous material may comprise a gauze, mesh or wad of metal, ceramic, glass or suitable plastic fibres depending upon the gas stream composition and temperature. Additionally or alternatively, a layer porous material may also be provided in the upper section of the distributor to reduce the velocity of gas exiting the section through its perforations and thereby increase liquid disengagement from the gas stream.

In one embodiment the distributor comprises a cylinder, open one (upper) end and closed at the opposite (lower) end, with upper and lower perforate sections having one or more conical liquid separation devices within said cylinder pointing toward the open end. Wet gas enters through the open end of the cylinder and entrained liquid is coalesced on the conical devices. Orifices are provided around the periphery of the cone to allow the coalesced liquid to pass to the lower section. Preferably a porous wire mesh is provided on the upper surface of the cone to improve liquid disengagement.

The perforations in the upper and lower sections may be holes or slots as previously used in existing gas distributors. In the upper section the perforations should be designed so that the liquid-depleted gas is provided evenly to the vessel. Preferably the perforations in the upper section provide radial flow to the vessel. Preferably the perforations in the lower section are not in the side walls but only at the distal end, so that the fluid flow from the lower section is axial and not radial with respect to the vessel. In one embodiment the lower perforate section is frusto-conical with perforations only in the distal end. This assists the liquid separated in the distributor to be directed to a specific portion of the vessel.

In use, wet gas enters the upper perforate section of the distributor through inlet means, liquid entrained in the gas is coalesced on the liquid separation means disposed between the upper and lower perforate sections, liquid-depleted gas passes out through orifices in the upper perforate section and liquid separated by the liquid separation means is collected in the lower perforate section. The liquid may then pass from the distributor as a liquid-enriched gas stream, or, depending upon the number, size and positioning of the perforations in the lower section begin to fill up the lower section. Preferably the separator is designed to prevent the liquid rising within the lower section to the level of the liquid separation means.

The gas distributor of the present invention is preferably used to separate liquids from gas streams where the liquid entrained in the gas stream is <25%, more preferably <10%, most preferably <5% by volume.

The effectiveness of the separator is increased by ensuring that the lower section has a higher pressure drop than the upper section, i.e. that the pressure differential between the lower section and the vessel is higher than the pressure differential between the upper section and the vessel. This may be achieved by having more and/or larger perforations in the upper section than in the lower section. We have found that it may be desirable to control the flow though the lower section, for example by changing the size/number or perforations, so that the gas flow in the lower section is less than 4 m/s.

If desired, screening means, such as a co-axial cylindrical baffle, may be provided within the upper perforate section of the distributor that prevents the gas entering the distributor from flowing directly out through the orifices in the upper section.

If desired, a wet gas distribution device may be provided at the inlet means of the distributor to cause the wet gas to flow in an even or uneven manner within the distributor. Preferably a wet gas distribution device is provided that forces the gas against the inside wall of the upper section of the distributor, particularly where the distributor is cylindrical. For example a wet gas rotation device, such as an impeller or series of curved baffles, may be provided at the inlet adjacent the upper section of the distributor. The rotation device causes the wet gas to swirl rotationally within the distributor and this acts to force the wet gas, particularly the larger, heavier liquid droplets against the inside wall of the upper section thereby increasing the surface for liquid disengagement from the gas and increasing separation. Increased axial flow of the wet gas within the distributor may also act to improve liquid disengagement on the separation means disposed between the upper and lower perforate sections.

In a preferred embodiment a wet gas rotation device is used in combination with screening means, in particular screening means that comprise an open ended co-axial body, such as a cylinder, having perforations therein that are connected, e.g. by means of tubing, to the perforations in the upper section of the distributor. In this way heavier liquid droplets entering through the inlet means are forced against the inside wall if the upper section but are prevented from flowing directly out through the perforations therein. Rather gas, depleted in liquid, passes from inside the co-axial body through the tubing between said cylinder and out of said upper section.

The distributor may be made of any suitable material such as metal or rigid plastics. Preferably the separator is fabricated from steels such as stainless steel, which may if desired have a protective coating.

In use the distributor will typically be located inside, adjacent the top of the vessel in which it is disposed, and may be aligned with the longitudinal axis of the vessel although this is not essential. The vessel is preferably a catalyst or sorbent vessel, i.e. a vessel in which one or more beds of a particulate catalyst or sorbent are disposed. Such vessels are typically cylindrical with domed ends through which the gas enters and exits the vessel and by which the catalyst or sorbent is typically loaded. However, the present invention is not restricted to such vessels. By “sorbent” we include both adsorbent and absorbent materials. The catalyst or sorbent is typically in the form of pellets, extrudates or granules with an average particle size in the range 1-30 mm. By particle size we mean the minimum particle dimension. Preferably therefore, the vessel comprises a shell with an entry port an opposed exit port and a bed of catalyst or sorbent disposed between said ports, with gas flow substantially axially through said bed of catalyst or sorbent. However the present gas distributor may also be used in vessels in which the bed of catalyst or sorbent is set up for radial flow, i.e. where the liquid-depleted gas is fed to the periphery of the bed and flows radially inwards to a central gas collector, or vice versa. In an axial flow catalyst or sorbent vessel, one or more layers of inert particulate materials may be provided above and/or below the bed of catalyst or sorbent. Ceramic materials and alpha alumina may be used. The preferred inert particulate material is alpha-alumina. The particle size of the inert material may be the same or different to that of the catalyst or sorbent to influence the flow of gas through the bed and in a preferred embodiment, layers of particulate inert material having a voidage the same or higher than the bed of catalyst or sorbent are provided above and below the bed. Preferred shapes for the layer above the bed are fluted rings as these provide a high geometric surface area with low pressure drop. The high geometric surface area maximises absorption of any remaining liquid in the liquid-depleted gas stream before it contacts the catalyst or sorbent bed. In a particularly preferred arrangement such an upper layer is combined with a lower layer of balls or fluted rings whose permeability, e.g. particle size, increases towards the gas collector. The gas collector may be any suitable collector known to those skilled in the art, e.g. a perforate plate, cylinder or cone or mesh or grid.

The liquid separated by the separation means disposed within the distributor may be piped directly from the distributor out of the vessel, however the gas distributor may alternately be arranged to direct the separated liquid to a specific part of the vessel.

For example, in catalyst or sorbent vessels, the gas distributor feed the separated liquid to a minor portion of the catalyst bed. In a preferred embodiment, the gas distributor extends to the surface of the catalyst or sorbent bed as this minimises the possibility of re-entrainment of the separated liquid in the liquid-depleted gas. In a particularly preferred embodiment a catalyst or sorbent vessel having the gas distributor of the present invention has conduit means that convey at least a portion of the liquid separated by the liquid separation means from the distributor through the catalyst or sorbent bed. The walls of the conduit means are preferably impermeable. Because the liquid stream from the distributor may contain gas on which the catalysis or sorbency is desirably carried out, the conduit means may contain catalyst or sorbent. The catalyst or sorbent disposed within the conduit means may be the same or different to that in the catalyst or sorbent bed. Preferably the catalyst or sorbent disposed in the conduit means may be one having a higher resistance to the action of the liquid that the remainder of the bed.

The conduit means is preferably an open-ended pipe. The conduit means may be fabricated from metal or a suitable plastic. Flexible or rigid plastics are particularly suitable as they may be readily introduced to the vessel through vessel manholes or inspection ports and installed, e.g. with in a bed of catalyst or sorbent, using established techniques.

The conduit means therefore contain the liquid stream as it passes through the bed of catalyst or sorbent. The conduit is therefore preferably sized so that it contains a minor portion (i.e. <50%, vol. particularly <30% vol.) of the catalyst or sorbent bed. Preferably the conduit means have an internal diameter in the range 10-25% of the vessel diameter. For example, in a specific example, a vessel of internal diameter 3.05 metres may have a central conduit of 0.46 metres internal diameter. The wall thickness of the conduit may for example be in the range 1-25 mm.

The vessel, and therefore the distributor, may be sized appropriately for the duty it is to perform. Industrial processes often utilise cylindrical vessels typically in the range 1 to 10 metres in length, preferably 0.3 to 6 metres in diameter. The vessels may be operated at atmospheric or elevated pressure at temperatures in the range −10 to 1000° C.

The gas distributor of the present invention may be used downstream of existing conventional gas/liquid separators.

In processes using the distributor of the present invention in combination with a catalyst or sorbent vessel, a feed gas containing entrained liquid, including possibly slugs of liquid is fed to the gas distributor in which liquid is separated and a liquid-depleted gas is distributed to a catalyst or sorbent bed and the separated liquid is preferably directed from the gas distributor to a minor portion of the catalyst or sorbent bed, especially a minor portion contained within conduit means that extend from the gas distributor through the catalyst or sorbent bed.

Catalytic processes in which the present distributor and vessel may find use include methanol synthesis, dimethyl ether synthesis, hydrodesulphurisation and the water-gas-shift reaction. Sorbency processes in which the present distributor and vessel may find use include sulphur compound, e.g. hydrogen sulphide, absorption, mercury absorption, arsinic absorption and chloride absorption. Details of suitable catalysts and sorbents may be found in chapters 4-9 of The Catalyst Handbook, 2^{nd} edition, Manson publishing, 1996, M. V. Twigg. Ed.

The present invention is of particular utility in sorption processes operated at atmospheric or elevated pressures at temperatures in the range −10 to 200° C., preferably 10-100° C.

For example, in one embodiment, the distributor and vessel of the present invention may be employed in the removal of hydrogen chloride from a hydrogen-rich gas stream obtained from a refinery CCR downstream of conventional gas-liquid separators. The hydrogen-rich stream after conventional separation technology still contains entrained liquid hydrocarbons (<5% vol). The liquid-containing hydrogen rich stream at 12 bar abs and about 30° C. is fed to the gas distributor where liquid is separated. The liquid-depleted gas is then fed to a bed of a chloride absorbent disposed within the vessel to remove the hydrogen chloride. The liquid-enriched gas stream from the distributor is passed through a conduit containing absorbent that passes through the bed. The purified gas and liquid streams are combined under the bed of absorbent and removed from the vessel.

The present invention provides a number of advantages over distributors of the prior art. The present distributor separates liquid entrained in gas streams and also is able to separate slugs of liquid carried over from upstream operations. In catalyst or sorbent vessels, the overall lifetime of the catalyst or sorbent is increased. The present distributor may be readily retro-fitted to existing vessels without changing the vessel set-up. The embodied designs are robust, simple in operation with no moving parts and hence require little maintenance, are low cost, and because they are fitted into the vessel they may be fitted into congested plant operations.

The invention is further described with reference to the following Figures in which;

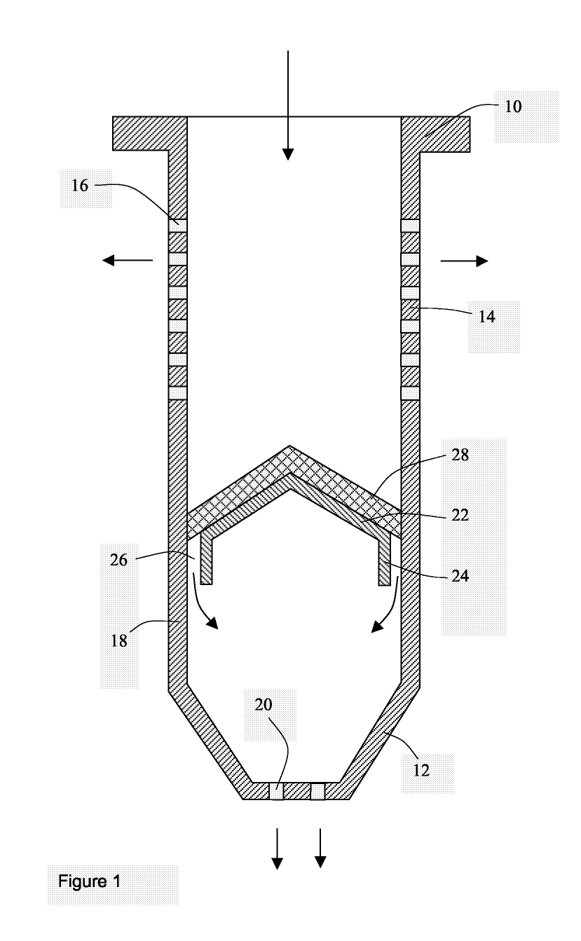

FIG. 1 depicts a cross section of one embodiment of a gas distributor according to the present invention,

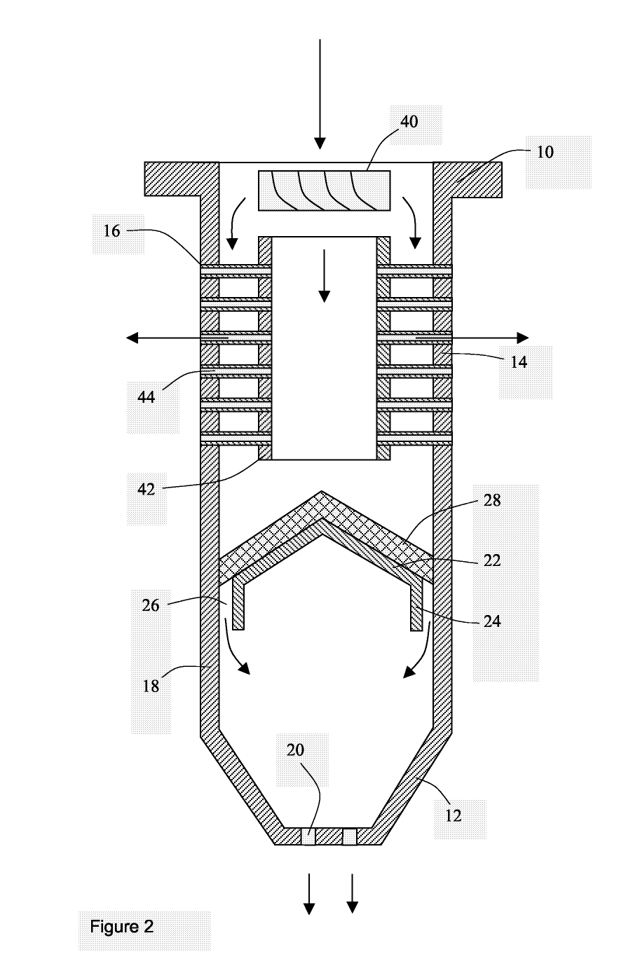

FIG. 2 depicts a cross section of a second embodiment of a gas distributor according to the present invention and;

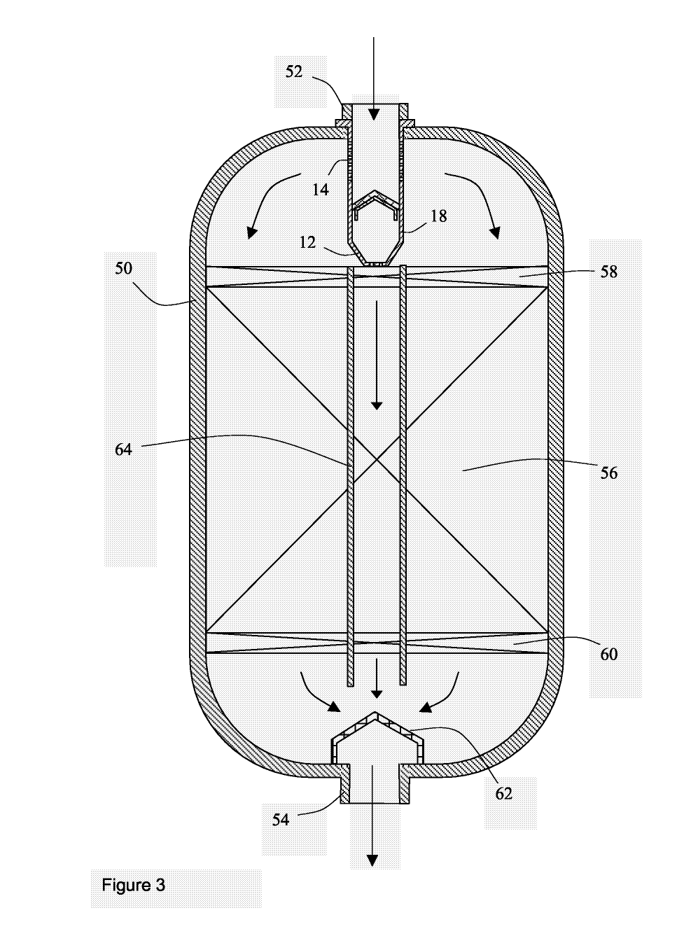

FIG. 3 depicts a cross section of one embodiment of a catalyst or sorbent vessel incorporating the gas distributor of FIG. 1. In the Figures, the flow of gas or liquid is illustrated by means of arrows.

In FIG. 1 there is a cylindrical gas distributor having an open flanged end 10 and an opposed closed frusto-conical end 12. The distributor comprises an upper section 14, having a plurality of orifices 16 in the side-walls of the cylinder. The lower section 18 of the distributor has no orifices in the side walls but one or more orifices 20 in the distal end of frusto-conical end 12. Within the distributor and between the upper 14 and lower 18 sections there is located a conical coalescing plate 22 located on supports 24. The inclination of the surface of the cone is about 45 degrees to the axis of the cylindrical body. The apex of the conical plate 22 points towards the open flanged end 10. A plurality of orifices 26 are provided around the periphery of conical plate 22. Supported on the conical plate 22 is an overlayer of wire mesh 28.

In use, wet gas is fed via open end 10 and axially downwards to upper section 14 where it contacts the mesh 28 and conical coalescing plate 22. Liquid entrained in the gas is coalesced on the conical plate 22 and its re-entrainment in the gas is retarded by mesh 28. The separated liquid flows down under gravity and via orifices 26 around the periphery of conical plate 22 to the lower section 18 of the distributor where it collects. Some gas may also pass through orifices 26. The liquid-depleted gas in upper section 14 passes radially through side-wall orifices 16 into the vessel (FIG. 3). The liquid-enriched gas stream in lower section 18 passes axially through end orifices 20 into the vessel (FIG. 3).

In FIG. 2 the embodiment of FIG. 1 further has a bladed impeller 40 disposed at the open end 10. Within upper section 14, disposed coaxially therein and forming an annular void, is an open ended cylindrical baffle 42 having orifices therein that are connected by tubes 44 with corresponding orifices 16 in said upper section 14.

In use, wet gas is fed via open end 10 to bladed impeller 40 which forces at least some of the gas against the inside walls of upper section 14. The gas flows axially downwards through the annular void formed between the inner wall of upper section 14 and the outside wall of cylindrical baffle 42 and also downwards within cylindrical baffle 42 and contacts the mesh 28 and conical coalescing plate 22. Liquid still entrained in the gas is coalesced on the inside wall of upper section 14 and on conical plate 22 and its re-entrainment in the gas is retarded by mesh 28. The separated liquid flows down under gravity and via orifices 26 around the periphery of conical plate 22 to the lower section 18 of the distributor where it collects. Some gas may also pass through orifices 26. The liquid-depleted gas in upper section 14 passes radially through tubes 44 linking the interior of the cylindrical baffle 42 with orifices 16 in upper section 14 and thence into the vessel. The liquid-enriched gas stream in lower section 18 passes axially through end orifices 20 into the vessel.

In FIG. 3 there is a pressure vessel comprising a cylindrical shell 50 with domed ends having opposed entry 52 and exit 54 ports aligned with the axis of the vessel. A gas distributor as depicted in FIG. 1 is installed adjacent the top of the vessel in the entry port 52. Within the vessel is disposed a fixed bed of particulate catalyst or sorbent 56 between upper 58 and lower 60 layers of alpha alumina or ceramic fluted rings or balls. The gas distributor extends to the surface of the upper ceramic 58. Beneath the lower layer of ceramic 60 are higher permeability ceramic balls or fluted rings (not shown) that support the bed. A perforate gas collector 62 is provided above the exit port 54 to prevent egress of the bed and ceramic material from the vessel 50. Disposed within the bed and extending vertically from the surface of the upper ceramic 58 though the bed 56 to the high permeability material beneath the lower layer 60 is a cylindrical pipe 64. The pipe 64 is co-axial with the gas distributor and has an internal diameter similar to that of the distributor. In this embodiment, the internal diameter of the pipe and is about 15% of the internal diameter of the vessel 50. Catalyst or sorbent 56 is disposed within the pipe 64.

In use, gas fed to entry port 52 passes into the distributor where liquid is separated. The liquid-depleted gas stream exits the upper section 14 of the distributor and is fed evenly to the surface of upper ceramic layer 58 and thence through the bed 56 and lower ceramic layer 60. The liquid-enriched gas stream in lower section 18 of the distributor is fed, with some liquid-depleted gas flowing past the frusto-conical end 12 of the distributor, from the bottom of the frusto-conical end 12 to the surface of the upper ceramic layer 58 and thence to the catalyst or sorbent 56 disposed within pipe 64. The liquid-enriched stream then passes over the catalyst or sorbent within the pipe and is prevented by the pipe from contacting the catalyst or sorbent in the remainder of the bed. The liquid-enriched stream and the liquid-depleted streams are re-combined beneath the lower ceramic layer 60 within the region of higher permeability ceramic. The combined streams pass through the perforate gas collector 62 and exit the vessel via port 54.

1. A gas distributor, for distributing a gas that contains an entrained liquid, comprising a body with an upper perforate section and a lower perforate section and liquid separation means disposed within said body between said upper and lower sections that is suitable for coalescing at least part of the liquid entrained in the gas, wherein said distributor comprises a cylinder with adjacent upper and lower perforate section having one or more conical liquid separation devices within said cylinder, said conical liquid separation device being arranged within the body so that a coalesced liquid may pass from the upper section to the lower section.

2. (canceled)

3. A distributor according to claim 1 wherein the conical liquid separation device has inclined surfaces and an overlayer of a porous material.

4. (canceled)

5. A distributor according to claim 1 wherein the lower perforate section is frusto-conical with perforations only in the distal end.

6. A distributor according to claim 1 wherein a wet gas distribution device is provided within the body that forces the gas against the inside wall of the upper section of the distributor.

7. A distributor according to claim 1 wherein a screening means is provided within the upper perforate section of the distributor that prevents gas entering the distributor from flowing directly out through the orifices in the upper section.

8. A vessel having a gas distributor according to claim 1.

9-11. (canceled)

12. A vessel according to claim 8 wherein the vessel comprises a shell with an entry port, an opposed exit port and a bed of catalyst or sorbent disposed between said ports, whereby the ports are arranged for ensuring a substantially axial gas flow through said bed of catalyst or sorbent.

13. A vessel according to claim 8 wherein the gas distributor extends to the surface of the catalyst or sorbent bed.

14. A vessel according to claim 8 having conduit means suitable to convey at least a portion of the liquid separated by the liquid separation means from the distributor through the catalyst or sorbent bed.

15. A vessel according to claim 14 wherein the conduit means contain catalyst or sorbent.

16. A vessel according to claim 14 wherein the conduit means are an open-ended pipe extending through the bed of catalyst or sorbent.

17. A vessel according to claim 14 wherein the conduit means have an internal diameter in the range 10-25% of the vessel diameter.

18. A process for distributing a gas containing an entrained liquid to a vessel comprising the steps;
(i) passing a gas stream containing entrained liquid to a gas distributor comprising: (1) a body having an upper perforate section and a lower perforate section and (2) liquid separation means disposed within said body between said upper and lower sections that is suitable for coalescing at least part of the liquid entrained in the gas, wherein said gas distributor comprises a cylinder with adjacent upper and lower perforate section having one or more conical liquid separation devices within said cylinder, said conical liquid separation device being arranged within the body so that a coalesced liquid may pass from the upper section to the lower section, and
(ii) passing the resulting liquid and liquid depleted gas streams through a vessel having the gas distributor.

19. A process according to claim 18 wherein the vessel contains a catalyst selected from a catalyst for the synthesis of methanol or dimethylether, hydrodesulphurisation or for the water-gas-shift reaction.

20. A process according to claim 18 wherein the vessel contains a sorbent suitable for sulphur absorption, mercury absorption, arsenic absorption or chloride absorption.
